(19) United States
(12) Patent Application Publication
(10) Pub. No.: US 2021/0035550 A1
(43) Pub. Date: Feb. 4, 2021

(54) ADVERTISEMENT PROCESSING APPARATUS AND ADVERTISEMENT PROCESSING METHOD FOR ADVERTISEMENT PROCESSING APPARATUS

(71) Applicant: TOSHIBA TEC KABUSHIKI KAISHA, Tokyo (JP)

(72) Inventor: Tomonori IKUMI, Numazu Shizuoka (JP)

(21) Appl. No.: 16/847,107

(22) Filed: Apr. 13, 2020

(30) Foreign Application Priority Data
Aug. 2, 2019 (JP) 2019-142696

(51) Int. Cl. G10L 13/08; G06F 16/35; G06F 16/583; G06Q 10/10; G06Q 30/02; G06F 40/20; G06K 9/46

(52) U.S. Cl. CPC G10L 13/08; G06F 16/353; G06F 16/5846; G06Q 10/10; G06K 2209/01; G06Q 30/0281; G06F 40/20; G06K 9/46; G06Q 30/0277

(57) ABSTRACT

According to an embodiment, an advertisement processing apparatus detects words or phrases from advertisement information. The advertisement processing apparatus determines, for each of the detected words or phrases, meaning of an advertisement represented by the corresponding words or phrases. The advertisement processing apparatus generates template data of sales talk on a basis of a combination of the determined meaning of the advertisement. The advertisement processing apparatus creates a sentence being sales talk from the generated template data and the detected words or phrases. The advertisement processing apparatus outputs the created sentence.

### CROSS-REFERENCE TO RELATED APPLICATIONS

This application is based upon and claims the benefit of priority from the prior Japanese Patent Application No. 2019-142696, filed on Aug. 2, 2019, the entire contents of which are incorporated herein by reference.

### FIELD

An embodiment to be described here generally relates to an advertisement processing apparatus and an advertisement processing method for an advertisement processing apparatus.

### BACKGROUND

In a retail store, an advertisement medium displaying an image, such as a POP (Point Of Purchase) advertisement or digital signage, is generally used for product sales promotion activities. However, merely showing the image to customers does not provide a sufficient sales promotion effect. By causing customers to hear the audio of a sales pitch along with the displayed image stimulates the willingness of customers to purchase and increases the sales promotion effect. In this regard, in the past, efforts have been made to promote sales by having a person in charge hold a microphone and stand in the store to provide a sales talk/pitch or to have the recorded audio of the sales talk/pitch repeatedly play backed.

However, in order cause customers to hear a sales talk, it is first necessary to create or compose a sentence for the sales talk. If such a sentence can be easily created, there is no problem. However, in general, it takes time and effort to create such a sentence for sales talks and often such time is wasteful time which might be better spent on other actions.

### BRIEF DESCRIPTION OF THE DRAWINGS

FIG. 1 is a block diagram illustrating a functional configuration of an advertisement processing apparatus according to a first embodiment.

FIG. 2 is a schematic diagram illustrating a data structure of a meaning information database according to the first embodiment.

FIG. 3 is a schematic diagram illustrating a data structure of a template database according to the first embodiment.

FIG. 4 is a block diagram illustrating a hardware configuration of the advertisement processing apparatus according to the first embodiment.

FIG. 5 is a schematic diagram illustrating an example of image data displayed on an advertisement medium in the first embodiment.

FIG. 6 is a flowchart illustrating main information processing executed by a processor of the advertisement processing apparatus according to the first embodiment.

FIG. 7 is a block diagram illustrating a functional configuration of an advertisement processing apparatus according to a second embodiment.

FIG. 8 is a flowchart illustrating main information processing executed by a processor of the advertisement processing apparatus according to the second embodiment.

### DETAILED DESCRIPTION

According to one embodiment, an advertisement processing apparatus includes: an input interface; an output interface; and a processor. The input interface inputs information of an advertisement. The output interface outputs data regarding a sentence. The processor detects words or phrases from the information of an advertisement input by the input interface. The processor determines, for each of the detected words or phrases, meaning of an advertisement represented by the corresponding words or phrases. The processor generates template data of sales talk on a basis of a combination of the determined meaning of the advertisement. The processor creates a sentence being sales talk from the generated template data and the detected words or phrases. Further, the processor outputs data regarding the created sentence via the output interface.

Hereinafter, an advertisement processing apparatus capable of easily creating a sentence for a sales talk according to an embodiment will be described with reference to the drawings. In the drawings, the same reference symbols indicate the same or similar components.

### First Embodiment

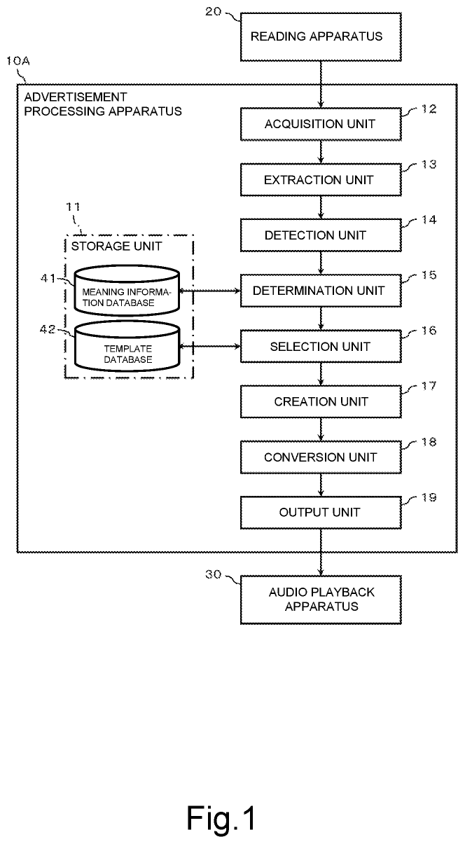

An advertisement processing apparatus 10A according to a first embodiment will be described first with reference to FIG. 1 to FIG. 6. The advertisement processing apparatus 10A creates, from an advertisement medium such as a POP (Point Of Purchase) advertisement and digital signage, a sales talk for sales promotion of a product being advertised in the advertisement medium.

FIG. 1 illustrates a function configuration of the advertisement processing apparatus 10A. The advertisement processing apparatus 10A includes, as main functions, a storage unit 11, an acquisition unit 12, an extraction unit 13, a detection unit 14, a determination unit 15, a selection unit 16, a creation unit 17, a conversion unit 18, and an output unit 19. Specifically, for example, a processor 101 described below operates as the functional units 11 to 19 as described below.

The storage unit 11 stores a meaning information database 41 and a template database 42 in a storage device. The storage device is, for example, an auxiliary storage device 103 described below. The storage device may be, for example, a main memory 102 described below. The storage unit 11 may store other data. Details of the meaning information database 41 and the template database 42 will be described below.

The acquisition unit 12 acquires, from a reading apparatus 20 via an input interface (IF) 104, image data read by the reading apparatus 20. The reading apparatus 20 reads an image of an advertisement medium. In the case where an advertisement medium is a POP advertisement, a scanner or multifunction peripheral that scans and reads the image displayed on the POP advertisement can be the reading apparatus 20. In the case where the reading apparatus 20 is a scanner or a multifunction peripheral, the data scanned by the scanner or the multifunction peripheral is image data read by the reading apparatus 20. In the case where the advertisement medium is digital signage, an imaging apparatus that images and reads the image displayed on the digital signage can be the reading apparatus 20. The imaging apparatus can be the reading apparatus 20 even in the case where the advertisement medium is a POP advertisement. The imaging apparatus may be a portable electronic apparatus such as a digital camera, smartphone, and a tablet terminal. In the case where the reading apparatus 20 is an imaging apparatus, the data imaged by the imaging apparatus is image data read by the reading apparatus 20. Upon acquiring the image data from the reading apparatus 20, the acquisition unit 12 outputs the image data to the extraction unit 13.

The extraction unit 13 extracts a text area from the image data. The text area is an area including characters and symbols. The text area may be an area in which characters and symbols are mixed. The text area may be an area including only characters or symbols. The extraction unit 13 extracts, as a text area, an area including a row of characters or symbols that are continuous along the line direction when an image is divided into a plurality of lines and read by the reading apparatus 20, i.e., the main scanning direction. The extraction unit 13 may extract, as a text area, an area including a row of characters or symbols that are continuous along the direction orthogonal to the line direction, i.e., the sub-scanning direction. The extraction unit 13 outputs, to the detection unit 14, information regarding all the text areas acquired by the extraction from the image data.

The detection unit 14 recognizes characters or symbols from a text area. The detection unit 14 recognizes characters or symbols included in the text area by using, for example, the optical character recognition (OCR) technology. Then, the detection unit 14 detects, from the characters or symbols recognized from the text area, words or phrases displayed on the text area. The words or phrases include a word or a phrase used in an advertisement of a product. For example, “meat”, “steak”, “food”, and the like used to represent the item name of a product, “yen”, “$”, “discount”, and the like used to represent the price of a product, “piece”, “gram”, and the like used to represent the quantity of products, and “sale”, “special price”, “bargain”, and the like used to represent a catchphrase of a product correspond to the words or phrases. The detection unit 14 outputs the data of words or phrases detected for each text area to the determination unit 15.

The determination unit 15 determines, for each of the words or phrases detected by the detection unit 14, the meaning of the advertisement represented by the corresponding words or phrases. Specifically, the determination unit 15 determines, with reference to the meaning information database 41, meaning information for each of the words or phrases detected for each text area. The meaning information is information for classifying the words or phrases in accordance with the meaning thereof. In the case of the above-mentioned example of the words or phrases, meaning information for “meat”, “steak”, “food”, and the like is “item”. The meaning information for “yen”, “discount”, and the like is “price”. The meaning information for “piece” and “gram” is “quantity”. The meaning information for “sale”, “special price”, “bargain”, and the like is “catchphrase”. Note that the classification items of the meaning information are not limited to the above-mentioned “item”, “price”, “quantity”, and “catchphrase”. Other classification items such as “period” and “customer segment” may be included as meaning information.

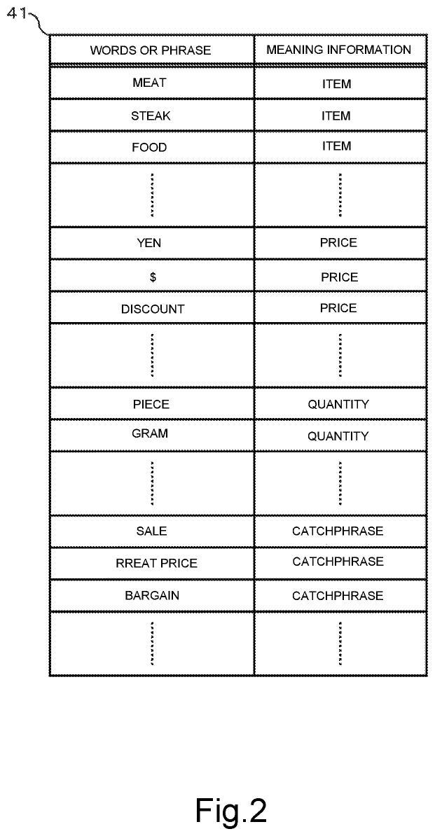

FIG. 2 schematically illustrates the data structure of the meaning information database 41. As shown in FIG. 2, the meaning information database 41 is a set of data records in which words or phrases and meaning information are associated with each other. Such data records can be created by tagging various words or phrases with meaning information. The tagging of various words or phrases with meaning information can be performed using, for example, a technology (annotation) of tagging AI learning data used in deep learning.

Now, FIG. 1 will be described again. The selection unit 16 generates template data of sales talk on the basis of the combination of pieces of meaning information of the advertisement determined by the determination unit 15 for each of the words or phrases. The selection unit 16 selects, with reference to the template database 42, template data matching the pattern of sales talk from the combination of pieces of meaning information determined by the determination unit 15 for each of the words or phrases. The template data is data imitating the pattern of sales talk. For example, in the case of considering sales talk in a pattern A, “Thank you sale is in progress. All frozen foods are discounted by 20%”, meaning information for the words or phrases of “Thank you sale is in progress” is “catchphrase”, meaning information of the words or phrases of “All frozen foods” is “item”, meaning information of the words or phrases of “discounted by 20%” is “price”. Therefore, the template data matching the pattern A of sales talk is “catchphrase”+“item”+“price”. For example, in the case of considering sales talk in a pattern B, “Thank you sale is in progress. Sirloin steak is 398 yen per 100 grams”, meaning information for the words or phrases of “Thank you sale is in progress” is “catchphrase”, meaning information for the words or phrases of “Sirloin steak” is “item”, meaning information for the words or phrases of “per 100 grams” is “quantity”, meaning information for the words or phrases of “398 yen” is “price”. Therefore, the template data matching the pattern B of sales talk is “catchphrase”+“item”+“quantity”+“price”. For example, in the case of considering sales talk in a pattern C, “Thank you sale is in progress. Sirloin steak is 398 yen per 100 grams. Bargain”, meaning information for the words or phrases of “Thank you sale is in progress” is “catchphrase”, meaning information for the words or phrases of “Sirloin steak” is “item”, meaning information for the words or phrases of “per 100 grams” is “quantity”, meaning information for the words or phrases of “398 yen” is “price”, and meaning information for the words or phrases of “Bargain” is “catchphrase”. Therefore, the template data matching the pattern C of sales talk is “catchphrase”+“item”+“quantity”+“price”+[catchphrase]. Note that in the case of changing sales talk in the pattern C to “Thank you sale is in progress. Sirloin steak is bargain. 398 yen per 100 grams”, the template data is “catchphrase”+“item”+[catchphrase]+“quantity”+“price”. For example, in the case of considering sales talk in a pattern D, “Pork is a great price”, meaning information for the words or phrases of “Pork” is “item”, meaning information for the words or phrases of “great price” is “catchphrase”. Therefore, the template data matching the pattern C of sales talk is “item”+“catchphrase”.

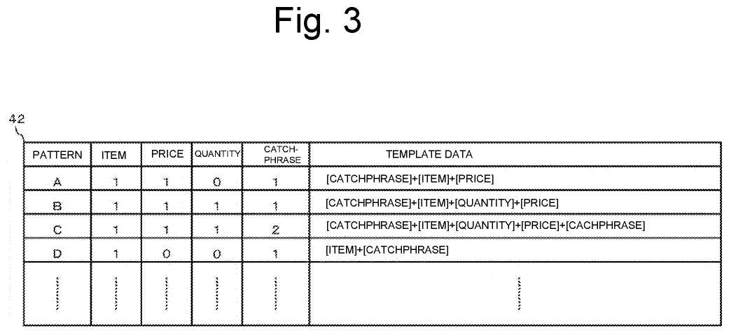

FIG. 3 is a schematic diagram illustrating the data structure of the template database 42. As shown in FIG. 3, the template database 42 is a set of data records in which a pattern of sales talk, numerical data for each piece of meaning information, template data are associated with each other. The numerical data represents the number of pieces of meaning information included in the corresponding pattern. In the case of the above-mentioned example of sales talk patterns, since the template data for the pattern A is “catchphrase”+“item”+“price”, the numerical data corresponding to each of the pieces of meaning information “item”, “price”, and “catchphrase” is “1”, and the numerical data corresponding to the meaning information “quantity” is “0”. Since the template data for the pattern B is “catchphrase”+“item”+“quantity”+“price”, the numerical data corresponding to each of the pieces of meaning information “item”, “price”, “quantity”, and “catchphrase” is “1”. Since the template data for the pattern C is “catchphrase”+“item”+“quantity”+“price”+“catchphrase”, the numerical data corresponding to each of the pieces of meaning information “item”, “price”, and “quantity” is “1”, and the numerical data corresponding to the meaning information “catchphrase” is “2”. Since the template data for the pattern D is “item”+“catchphrase”, the numerical data corresponding to each of the pieces of meaning information “item” and “catchphrase” is “1”, and the numerical data corresponding to each of the pieces of meaning information “price” and “quantity” is “0”. It goes without saying that in the case where “period”, “customer segment”, or the like is added as meaning information, the items of the numerical data in the template database 42 change accordingly.

Now, FIG. 1 will be described again. The creation unit 17 creates a sentence being sales talk from the template data selected by the selection unit 16 and the words or phrases associated with the meaning information determined by the determination unit 15. For example, in the case where the template data is the pattern A, the words or phrases associated with the meaning information “catchphrase” are “Thank you sale”, the words or phrases associated with the meaning information “item” are “All frozen foods”, and the words or phrases associated with the meaning information “price” are “discounted by 20%”, the creation unit 17 creates “Thank you sale is in progress. All frozen foods are discounted by 20%” as a sentence being sales talk. For example, in the case where the template data is the pattern B, the words or phrases associated with the meaning information “catchphrase” are “Thank you sale”, the words or phrases associated with the meaning information “item” are “Sirloin steak”, the words or phrases associated with the meaning information “quantity” are “100 grams”, and the words or phrases associated with the meaning information “price” are “398 yen”, the creation unit 17 creates a sentence of “Thank you sale is in progress. Sirloin steak is 398 yen per 100 grams” as a sentence being sales talk. Since the same applies to the cases of the pattern C and the pattern D, description thereof will be omitted. Such creation of a sentence can be realized by preparing a corpus that is a language database and using an existing technology of sentence creation software.

The conversion unit 18 converts the sentence of sales talk created by the creation unit 17 into audio data. The conversion unit 18 converts the sentence of sales talk into audio data by, for example, using a text-to-speech synthesis technology called TTS (Text To Speech).

The output unit 19 outputs, to an audio playback apparatus 30 via an output interface (I/F) 105, audio data acquired by the conversion unit 18. The audio playback apparatus 30 is a known apparatus including an audio recording module, an audio playback module, and a speaker. The audio playback apparatus 30 records, by the operation of the audio recording module, the audio data output from the output unit 19. Then, the audio playback apparatus 30 repeatedly plays back the recorded audio data from the speaker by the operation of the audio playback module in response to a playback command. Further, the audio playback apparatus 30 stops playback of the audio data in response to a stop command. The playback command and stop commands are automatically given from, for example, a timer. The playback command and stop commands may be artificially given via an operation device such as a keyboard.

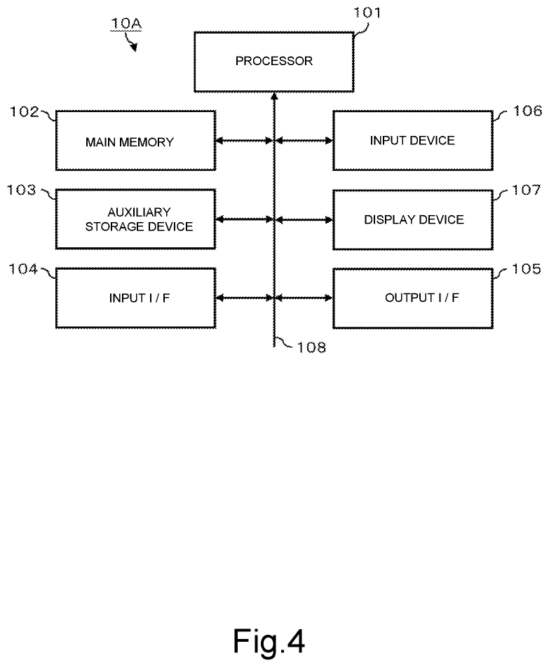

FIG. 4 illustrates a hardware configuration of the advertisement processing apparatus 10A. The advertisement processing apparatus 10A includes the processor 101, the main memory 102, the auxiliary storage device 103, the input interface 104, the output interface 105, an input device 106, a display device 107, and a system transmission path 108. The system transmission path 108 includes an address bus, a data bus, a control signal line, and the like. The processor 101, the main memory 102, the auxiliary storage device 103, the input interface 104, the output interface 105, the input device 106, and the display device 107 are connected to the system transmission path 108. In the advertisement processing apparatus 10A, the processor 101, the main memory 102, the auxiliary storage device 103, and the system transmission path 108 connecting them configures a computer.

The processor 101 corresponds to a central part of the computer. The processor 101 controls the respective unit in accordance with an operating system or an application program in order to realize the above-mentioned various functions as the advertisement processing apparatus 10A. The processor 101 is, for example, a CPU (Central Processing Unit).

The main memory 102 corresponds to a main storage part of the computer. The main memory 102 includes a non-volatile memory area and a volatile memory area. The main memory 102 stores an operating system or an application program in the non-volatile memory area. The main memory 102 stores, in the non-volatile or volatile memory area, data necessary for the processor 101 to execute processing for controlling the respective units in some cases. The main memory 102 uses the volatile memory area as a work area in which data is appropriately rewritten by the processor 101. The non-volatile memory area is, for example, a ROM (Read Only Memory). The volatile memory area is, for example, a RAM (Random Access Memory).

The auxiliary storage device 103 corresponds to an auxiliary storage part of the computer. For example, an EEPROM (Electric Erasable Programmable Read-Only Memory), an HDD (Hard Disc Drive), an SSD (Solid State Drive), or the like can be the auxiliary storage device 103. The auxiliary storage device 103 stores data to be used when the processor 101 performs various types of processing, data created by processing by the processor 101, and the like. The auxiliary storage device 103 stores the above-mentioned application program in some cases.

The input interface 104 inputs advertisement information. For example, the input interface 104 is an input interface for the reading apparatus 20. The input interface 104 transmits/receives a data signal to/from the reading apparatus 20 in accordance with a predetermined communication protocol. By the transmission/reception, the input interface 104 inputs image data that is advertisement information read by the reading apparatus 20.

The output interface 105 outputs data regarding the created sentence. For example, the output interface 105 is an output interface for the audio playback apparatus 30. The output interface 105 transmits/receives a data signal to/from the audio playback apparatus 30 in accordance with a predetermined communication protocol. By the transmission/reception, the output interface 105 outputs audio data of the created sentence to the audio playback apparatus 30.

The input device 106 receives an input of an instruction command to the processor 101. A keyboard, a pointing device, a touch panel, or the like can be used as the input device 106.

The display device 107 appropriately displays an image in response to an instruction from the processor 101. A liquid crystal display, an organic EL (Electroluminescence) display, or the like is used as the display device 107.

In the above-mentioned configuration, the computer mainly including the processor 101 realizes the function as the above-mentioned storage unit 11 in cooperation with the auxiliary storage device 103. Further, the computer mainly including the processor 101 realizes the function as the acquisition unit 12 in cooperation with the input interface 104. Similarly, the computer mainly including the processor 101 realizes the function as the output unit 19 in cooperation with the output interface 105. Further, the computer mainly including the processor 101 realizes the functions as the extraction unit 13, the detection unit 14, the determination unit 15, the selection unit 16, the creation unit 17, and the conversion unit 18. The processor 101 executes information processing in accordance with a control program that is a type of application program stored in the main memory 102 or the auxiliary storage device 103, thereby realizing these functions.

Note that the method of installing the control program in the main memory 102 or the auxiliary storage device 103 is not particularly limited. The control program can be installed in the main memory 102 or the auxiliary storage device 103 by recording the control program on a removable recording medium or delivering the control program through communication a network. The recording medium may be in any form as long as it is capable of recording a program and can be read by an apparatus, like a CD-ROM, a memory card, or the like.

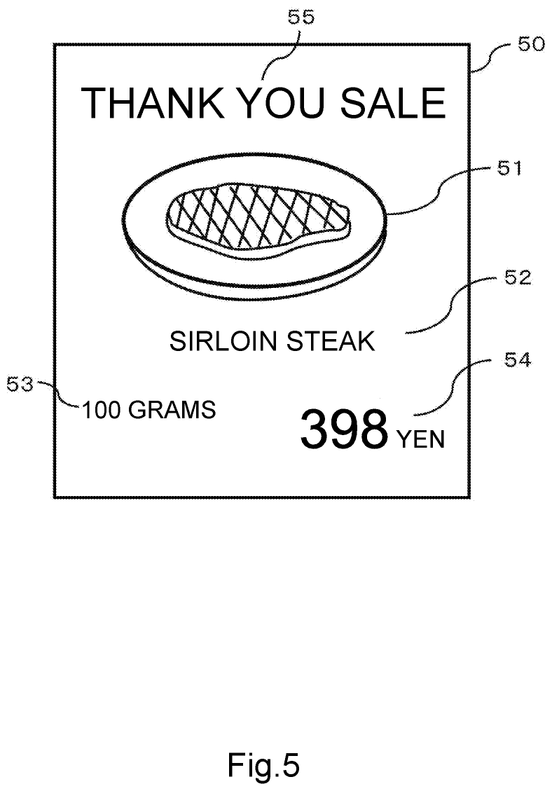

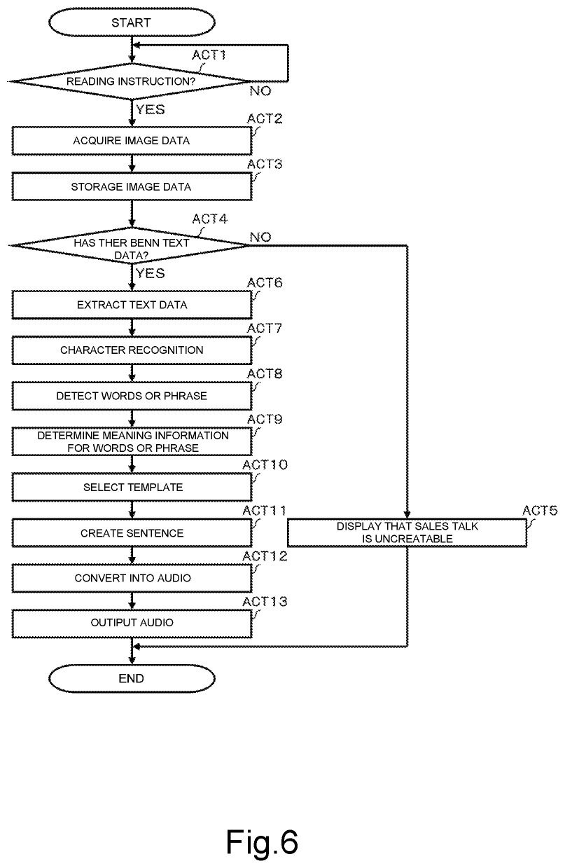

Next, an operation example of the advertisement processing apparatus 10A will be described with reference to FIG. 5 and FIG. 6. FIG. 5 illustrates an example of image data 50 displayed on an advertisement medium. The image data 50 is printed on, for example, a paper medium to be a POP advertisement. The image data 50 is displayed on, for example, a screen of digital signage. As shown in FIG. 5, the image data 50 includes an image 51 representing a sirloin steak placed on a plate, and text data of words or phrases “Sirloin steak” 52, words or phrases “100 grams” 53, words or phrases “398 yen” 54, and words or phrases “Thank you sale” 55.

FIG. 6 illustrates a procedure of main information processing executed by the processor 101 in accordance with a control program. Note that the content of the processing that is shown in FIG. 6 and described below is an example. The processing procedure and processing content are not particularly limited as long as similar results can be obtained.

The advertisement processing apparatus 10A displays a job menu screen on the display device 107 in the default state. The job menu includes a job for creating sales talk. When the job for creating sales talk is selected from the job menu via the input device 106, a control program is started. By the starting of the control program, the processor 101 starts the information processing in the procedure shown in FIG. 6. In ACT1, the processor 101 stands by for a reading instruction.

The person in charge of creating sales talk from the image data 50 operates the reading apparatus 20 to read the image data 50 displayed on the advertisement medium. Further, the person in charge operates the input device 106 to select the job for creating sales talk. Upon receiving these operations, the processor 101 determines that there has been a reading instruction. In the case where it is determined that there has been a reading instruction (YES in ACT1), the processing of the processor 101 proceeds to ACT2.

In ACT2, the processor 101 (acquisition unit 12) controls the input interface 104 to acquire the image data 50 read by the reading apparatus 20. Then, in ACTS, the processor 101 stores the above-mentioned image data 50 in an image memory. The image memory is formed in, for example, a volatile area of the main memory 102.

In ACT4, the processor 101 analyzes the image data 50 stored in the image memory. Then, the processor 101 determines whether or not there is a text area in the image data 50. In the case where it is determined that there is no text area in the image data 50 (NO in ACT4), the processing of the processor 101 proceeds to ACT5. In ACT5, the processor 101 performs processing of displaying that sales talk is uncreatable. For example, the processor 101 causes the display device 107 to display an error message indicating that sales talk is not creatable. In the case where there is no text area in the image data 50, then, the processor 101 finishes the information processing shown in FIG. 6.

Meanwhile, in the case where it is determined that there has been a text area in the image data 50 (YES in ACT4), the processing of the processor 101 proceeds to ACT6. In ACT6, the processor 101 (extraction unit 13) extracts all text areas from the stored image data 50 described above. That is, the processor 101 extracts, from , for example, the image data 50 shown in FIG. 5, a text area of the words or phrases “Sirloin steak” , a text area of the words or phrases “100 grams” 53, a text area of the words or phrases “398 yen” 54, and a text area of the words or phrases “Thank you sale” 55. Note that in the following, for convenience of description, the text area of the words or phrases “Sirloin steak” 52 is defined as the text area 52T, the text area of the words or phrases “100 grams” 53 is defined as the text area 53T, the text area of the words or phrases “398 yen” 54 is defined as the text area 54T, and the text area of the words or phrases “Thank you sale” 55 is defined as the text area 55T.

After completing the extraction of the text areas 52T, 53T, 54T, and 55T from the image data 50, the processor 101 performs character recognition for each of the text areas 52T, 53T, 54T, and 55T in ACT7. Then, in ACT8, the processor 101 (detection unit 14) detects words or phrases in the corresponding text area on the basis of the characters, numerals, symbols, or the like recognized for each of the text areas 52T, 53T, 54T, and 55T. That is, the processor 101 detects the words or phrases “Sirloin steak” 52 by the characters or the like recognized from the text area 52T. Further, the processor 101 detects the words or phrases “100 grams” 53 by the characters or the like recognized from the text area 53T. Further, the processor 101 detects the words or phrases “398 yen” 54 by the characters or the like recognized from the text area 54T. Further, the processor 101 detects the words or phrases “Thank you sale” 55 by the characters or the or the like recognized from the text area 55T.

Upon finishing the detection of the words or phrases from all the text areas 52T to 55T, the processor 101 determines, for each of the words or phrases, the meaning of the advertisement represented by the corresponding words or phrases in ACTS. That is, the processor 101 determines the meaning information for the words or phrases with reference to the meaning information database 41. More specifically, the processor 101 (determination unit 15) determines that the meaning information for the words or phrases “Sirloin steak” 52 is “item”. Further, the processor 101 determines that the meaning information for the words or phrases “100 grams” 53 is “quantity”. Further, the processor 101 determines that the meaning information for the words or phrases “398 yen” 54 is “price”. Further, the processor 101 determines that the meaning information for the words or phrases “Thank you sale” 55 is “catchphrase”.

Upon finishing the determination of meaning information for all the words or phrases, the processor 101 generates, in ACT10, template data of sales talk on the basis of the combination of the above-mentioned meaning information of the advertisement determined for each of the words or phrases. Specifically, for example, the processor 101 selects, with reference to the template database 42, template data for the pattern determined by the number of pieces of meaning information and the combination of meaning information. That is, the processor 101 (selection unit 16) selects the template data “[catchphrase]+[item]+[quantity]+[price]” for the pattern B because the combination of meaning information determined for all of the words or phrases is “item”, “price”, “quantity”, and “catchphrase”.

Upon finishing the selection of template data, the processor 101 creates, in ACT11, a sentence of sales talk from the selected templated data and detected words or phrases described above. That is, the processor 101 (creation unit 17) rearranges the words or phrases in accordance with the template data [catchphrase]+[item]+[quantity]+[price] for the pattern B because the meaning information for the words or phrases “Sirloin steak” 52 is [item], the meaning information for the words or phrases “100 grams” 53 is [quantity], the meaning information for the words or phrases “398 yen” 54 is [price], and the meaning information for the words or phrases “Thank you sale” 55 is [catchphrase]. In this way, the processor 101 creates a sentence of sales talk “Thank you sale is in progress. Sirloin steak is 398 yen per 100 grams”.

After creating the sentence of sales talk, the processor 101 (conversion unit 18) converts the sentence into audio data in ACT12. Then, in ACT13, the processor 101 (output unit 19) controls the output interface 105 to causes the output interface 105 to output the audio data to the audio playback apparatus 30. By the control, audio data of sales talk “Thank you sale is in progress. Sirloin steak is 398 yen per 100 grams” is output from the output interface 105 to the audio playback apparatus 30. Thus, the processor 101 finishes the information processing shown in FIG. 6.

The audio playback apparatus 30 records audio data of sales talk. Then, the audio playback apparatus 30 repeatedly plays back audio of sales talk “Thank you sale is in progress. Sirloin steak is 398 yen per 100 grams”.

Here, the advertisement processing apparatus 10A realizes the function as the acquisition unit 12 by the processing of ACT1 and ACT2 executed by the processor 101. Then, the advertisement processing apparatus 10A realizes the function as the acquisition unit 12, thereby constituting an image data acquisition means for acquiring image data of an advertisement medium read by the reading apparatus 20.

Further, the advertisement processing apparatus 10A realizes the functions as the extraction unit 13 and the detection unit 14 by the processing of ACTS to ACT8 executed by the processor 101. Then, the advertisement processing apparatus 10A realizes the functions as the extraction unit 13 and the detection unit 14, thereby constituting a detection means for detecting words or phrases from advertisement information.

Further, the advertisement processing apparatus 10A realizes the function as the determination unit 15 by the processing of ACTS executed by the processor 101. Then, the advertisement processing apparatus 10A realizes the function as the determination unit 15, thereby constituting a determination means for determining, for each of the words or phrases detected by the detection means, meaning information of an advertisement represented by the corresponding words or phrases.

Further, the advertisement processing apparatus 10A realizes the function as the selection unit 16 by the processing of ACT10 executed by the processor 101. Then, the advertisement processing apparatus 10A realizes the function as the selection unit 16, thereby constituting a selection means for selecting template data of sales talk on the basis of the combination of meaning information of the advertisement determined for each of the words or phrases by the determination means.

Further, the advertisement processing apparatus 10A realizes the function as the creation unit 17 by the processing of ACT11 executed by the processor 101. Then, the advertisement processing apparatus 10A realizes the function as the creation unit 17, thereby constituting a creation means for creating a sentence being sales talk from the template data selected by the selection means and the words or phrases detected by the detection means.

Further, the advertisement processing apparatus 10A realizes the function as the conversion unit 18 by the processing of ACT12 executed by the processor 101. Then, the advertisement processing apparatus 10A realizes the function as the conversion unit 18, thereby constituting a conversion means for converting the sentence created by the creation means into audio data.

The advertisement processing apparatus 10A functions as the output unit 19 by the processing of ACT13 executed by the processor 101. Then, the advertisement processing apparatus 10A realizes the function as the output unit 19, thereby constituting an output means for outputting the sentence created by the creation means, specifically, an output means for outputting, to the audio playback apparatus 30, audio data converted from the sentence.

As described in detail above, in accordance with the advertisement processing apparatus 10A according to this embodiment, it is possible to easily create, from an advertisement medium such as a POP advertisement and digital signage, a sentence of sales talk matching the content to be advertised by the advertisement medium. In addition, in accordance with the advertisement processing apparatus 10A, it is possible to covert the sentence of sales talk into audio data, and output the obtained audio data to the audio playback apparatus 30. Therefore, by disposing a speaker of the audio playback apparatus 30 near an advertisement medium such as a POP advertisement and digital signage and repeatedly playing back audio data by the audio playback apparatus 30, it is possible to cause customers to hear audio of sales talk reflecting the image of the advertisement medium and the content of the advertisement. Therefore, it is possible to further enhance the sales promotion effect without burdening the person in charge of sales talk.

### Second Embodiment

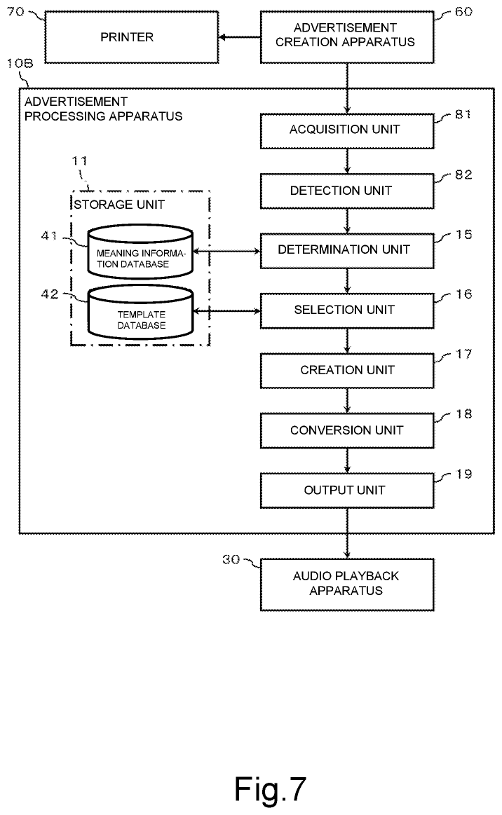

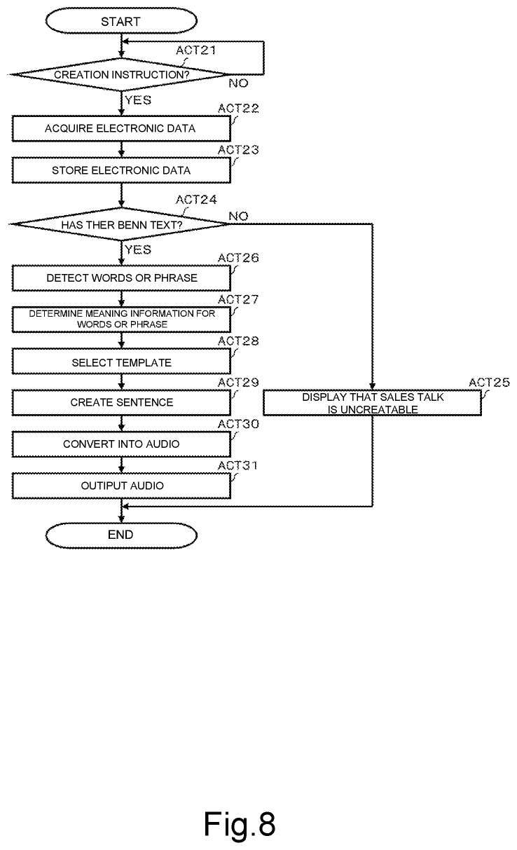

Next, an advertisement processing apparatus 10B according to an embodiment of the present technology, which creates, from electronic data for creating an advertisement medium, sales talk for sales promotion of a product advertised by the advertisement medium, will be described with reference to FIG. 7 and FIG. 8. Note that of FIG. 1 to FIG. 6 used in the first embodiment, FIG. 2 to FIG. 5 will be used as they are and description thereof will be omitted. However, the input interface 104 in FIG. 4 is replaced with the input interface 104 for an advertisement creation apparatus.

FIG. 7 illustrates a functional configuration of the advertisement processing apparatus 10B. The advertisement processing apparatus 10B includes, as main functions, the storage unit 11, an acquisition unit 81, a detection unit 82, the determination unit 15, the selection unit 16, the creation unit 17, the conversion unit 18, and the output unit 19. Of these functions, the storage unit 11, the determination unit 15, the selection unit 16, the creation unit 17, the conversion unit 18, and the output unit 19 are the same as those in the advertisement processing apparatus 10A according to the first embodiment, and thus, are denoted by the same reference symbols, and detailed description thereof will be omitted.

That is, the functions of the acquisition unit 81 and the detection unit 82 in the advertisement processing apparatus 10B according to the second embodiment is different from that in the advertisement processing apparatus 10. The acquisition unit 81 acquires electronic data from an advertisement creation apparatus 60 via the input interface 104.

The advertisement creation apparatus 60 is an apparatus that creates a POP advertisement. In order to create a POP advertisement on which the image data 50 shown in FIG. 5 has been displayed, the image 51 representing a sirloin steak placed on a plate, and text data of the words or phrases “Sirloin steak” 52, the words or phrases “100 grams” 53, the words or phrases “398 yen” 54, and the words or phrases “Thank you sale” 55 are necessary. The advertisement creation apparatus 60 creates the image data 50 by combining the image 51 and the text data of the words or phrases 52 to 55. The advertisement creation apparatus 60 outputs the image data 50 to a printer 70 for printing a POP advertisement. When the image data 50 is output in this way, the printer 70 operates to create a POP advertisement on which the image data 50 has been printed.

The advertisement creation apparatus 60 may be an apparatus that creates image data to be displayed on digital signage. In this case, the advertisement creation apparatus 60 outputs the image data 50 not to the printer 70 but to a control apparatus of digital signage.

The acquisition unit 81 acquires electronic data including the image 51 and text data of the words or phrases 52 to 55 from the advertisement creation apparatus 60. Upon acquiring the electronic data from the advertisement creation apparatus 60, the acquisition unit 81 outputs the acquired electronic data to the detection unit 82.

The detection unit 82 extracts text data from the electronic data output from the acquisition unit 81. Then, the detection unit 82 detects, for each of the extracted text data, words or phrases including the corresponding text data. The detection unit 14 outputs, to the determination unit 15, data of the words or phrases detected for each of the text data. Note that the processing of extracting the text data from the electronic data may be performed by the acquisition unit 81 at the preceding stage.

FIG. 8 illustrates the procedure of main information processing executed by the processor 101 of the advertisement processing apparatus 10B in accordance with a control program. Note that the content of the processing that is shown in FIG. 8 and described below is an example. The processing procedure and processing content are not particularly limited as long as similar results can be obtained.

Also the advertisement processing apparatus 10B displays a job menu screen on the display device 107 in the default state, similarly to the advertisement processing apparatus 10A. Then, when the job for creating sales talk is selected from the job menu via the input device 106, a control program is started. By the starting of the control program, the processor 101 starts the information processing in the procedure shown in FIG. 8. In ACT21, the processor 101 stands by for a creation instruction.

The person in charge who has created the POP advertisement using the advertisement creation apparatus 60 operates the input device 106 to select a job for creating sales talk. Upon receiving the operation, the processor 101 recognizes that there has been a creation instruction. In the case where it is recognized that there has been a creation instruction (YES in ACT21), the processing of the processor 101 proceeds to ACT22.

In ACT22, the processor 101 controls the input interface 104. Then, the processor 101 (acquisition unit 81) acquires the electronic data that has been used for creating the POP advertisement from the advertisement creation apparatus 60 via the input interface 104. Then, in ACT23, the processor 101 stores the electronic data in an electronic data memory. The electronic data memory is formed in, for example, a volatile area of the main memory 102.

In ACT24, the processor 101 analyzes the electronic data stored in the electronic data memory. Then, the processor 101 checks whether or not the electronic data includes text data. In the case where the electronic data includes no text data (NO in ACT24), the processing of the processor 101 proceeds to ACT25. In ACT25, the processor 101 performs processing of displaying that sales talk is uncreatable. For example, the processor 101 causes the display device 107 to display an error message indicating that sales talk is not creatable. In the case where the electronic data includes no text data, then, the processor 101 finishes the information processing shown in FIG. 8.

Meanwhile, in the case where the above-mentioned electronic data includes text data (YES in ACT24), the processor 101 proceeds to ACT26. In ACT26, the processor 101 detects words or phrases from the above-mentioned text data.

For example, in the case where the acquisition unit 81 has acquired the electronic data for creating the POP advertisement of the image data 50 shown in FIG. 5, the text data includes the text data of the words or phrases “Sirloin steak” 52, the text data of the words or phrases “100 grams” 53, the text data of the words or phrases “398 yen” 54, and the text data of the words or phrases “Thank you sale” 55. Note that in the following, for convenience of description, the text data of the words or phrases “Sirloin steak” 52 is defined as the text data 52D, the text data of the words or phrases “100 grams” 53 is defines as the text data 53D, the text data of the words or phrases “398 yen” 54 is defines as the text data 54D, and the text data of the words or phrases “Thank you sale” 55 is defined as the text data 55D.

The processor 101 (detection unit 82) detects the words or phrases “Sirloin steak” 52 from the text data 52D. Further, the processor 101 detects the words or phrases “100 grams” 53 from the text data 53D. Further, the processor 101 detects the words or phrases “398 yen” 54 from the text data 54D. Further, the processor 101 detects the words or phrases “Thank you sale” 55 from the text data 55D.

When the processor 101 finishes the detection of the words or phrases from all the text data 52D to 55D, the processing of the processor 101 proceeds to Act27. Then, in ACT27 to ACT31, the processor 101 executes the same processing as that in ACTS to ACT13 described in the first embodiment. That is, the processor 101 realizes the functions as the determination unit 15, the selection unit 16, the creation unit 17, the conversion unit 18, and the output unit 19. Thus, the processor 101 finishes the information processing shown in FIG. 8.

Note that the advertisement processing apparatus 10B realizes the function as the acquisition unit 81 by the processing of ACT21 and ACT22 executed by the processor 101. Then, the advertisement processing apparatus 10B realizes the function as the acquisition unit 81, thereby constituting an electronic data acquisition means for acquiring, from the advertisement creation apparatus 60 that creates an advertisement medium, electronic data for creating the advertisement medium.

Further, the advertisement processing apparatus 10B realizes the function as the detection unit 82 by the processing of ACT23 to ACT25 executed by the processor 101. Then, the advertisement processing apparatus 10B realizes the function as the detection unit 82, thereby constituting the detection means.

Further, the advertisement processing apparatus 10B realizes the function as the determination unit 15 by the processing of ACT27 executed by the processor 101. Then, the advertisement processing apparatus 10B realizes the function as the determination unit 15, thereby constituting the determination means. Further, the advertisement processing apparatus 10B realizes the function as the selection unit 16 by the processing of ACT28 executed by the processor 101. Then, the advertisement processing apparatus 10B realizes the function as the selection unit 16, thereby constituting the selection means. Further, the advertisement processing apparatus 10B realizes the function as the creation unit 17 by the processing of ACT29 executed by the processor 101. Then, the advertisement processing apparatus 10B realizes the function as the creation unit 17, thereby constituting the creation means. Further, the advertisement processing apparatus 10B realizes the function as the conversion unit 18 by the processing of ACT30 executed by the processor 101. Then, the advertisement processing apparatus 10B realizes the function as the conversion unit 18, thereby constituting the conversion means. Further, the advertisement processing apparatus 10B realizes the function as the output unit 19 by the processing of ACT31 executed by the processor 101. Then, the advertisement processing apparatus 10B realizes the function as the output unit 19, thereby constituting the output means.

In this way, also the advertisement processing apparatus 10B according to the second embodiment is capable of achieving the same effects as those in the advertisement processing apparatus 10A according to the first embodiment. In addition, in accordance with the advertisement processing apparatus 10B, the function as the extraction unit 13 is unnecessary, and also the function of character recognition by the detection unit 82 is unnecessary. For this reason, in accordance with the advertisement processing apparatus 10B, there is an advantage that it is possible to reduce the processing load of the processor 101 and create sales talk more quickly. Further, in accordance with the advertisement processing apparatus 10B, it is possible to create sales talk of a product to be advertised by an advertisement medium at substantially the same time as the creation of the advertisement medium.

Although the advertisement processing apparatuses 10A and 10B according to the embodiments capable of easily creating a sentence being sales talk have been described above, such embodiments are not limited thereto. For example, in the above-mentioned embodiments, the advertisement processing apparatuses 10A and 10B covert the sentence of sales talk into audio data and output the obtained audio data to the audio playback apparatus 30. However, the advertisement processing apparatuses 10A and 10B do not necessarily need to convert the sentence of sales talk into audio data. In the case where the audio playback apparatus 30 has the function of converting text data into audio data, the advertisement processing apparatuses 10A and 10B only needs to output, to the audio playback apparatus 30, data constituting the sentence of sales talk.

Further, the advertisement processing apparatuses 10A and 10B are capable of causing customers to hear sales talk with audio close to the voice of a main person such as a store manager by causing the audio playback apparatus 30 to learn the voice of the voice of the main person as audio data.

In the above-mentioned embodiments, the case in which the meaning information database 41 and the template database 42 are stored in the storage unit 11 of the advertisement processing apparatus 10A or 10B has been illustrated. In another embodiment, the meaning information database 41 and the template database 42 are stored in a storage apparatus connected to the advertisement processing apparatuses 10A and 10B via a network. Then, the processors 101 of the respective advertisement processing apparatuses 10A and 10B may access the storage apparatus and search the meaning information database 41 and the template database 42. In this way, since the capacity of the storage units 11 of the respective advertisement processing apparatuses 10A and 10B can be reduced , there is an advantage that the advertisement processing apparatuses 10A and 10B can be configured at low cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An advertisement processing apparatus, comprising:
an input interface that inputs information of an advertisement;
an output interface that outputs data regarding a sentence; and
a processor configured to:
detect words or phrases from the information of an advertisement input by the input interface,
determine, for each of the detected words or phrases, meaning of an advertisement represented by the corresponding words or phrases,
generate template data of sales talk on a basis of a combination of the determined meaning of the advertisement,
create a sentence being sales talk from the generated template data and the detected words or phrases, and
output data regarding the created sentence via the output interface.

2. The advertisement processing apparatus according to claim 1, further comprising:
a storage device that stores a meaning information database, the meaning information database being a set of data records in which the words or phrases and meaning information are associated with each other, the meaning information being information for classifying the words or phrases in accordance with meaning of the respective words or phrases, wherein
the processor determines, with reference to the meaning information database stored in the storage device, meaning information for each of the detected words or phrases, and
the processor generates the template data of sales talk on a basis of a combination of the determined meaning information.

3. The advertisement processing apparatus according to claim 2, wherein
the storage device further stores a template database, the template database being a set of data records in which a pattern of the sales talk, numerical data for each piece of meaning information, template data are associated with each other, the template data being data imitating the pattern of the sales talk, and
the processor selects, with reference to the template database stored in the storage device, template data matching the pattern of the sales talk from the combination of the determined meaning information.

4. The advertisement processing apparatus according to claim 1, wherein the processor is configured to:
acquire, as the information of an advertisement, image data of an advertisement medium via the input interface, and
extract an area of characters from the acquired image data of an advertisement medium and then recognize characters from the area to detect the words or phrases.

5. The advertisement processing apparatus according to claim 1, wherein the processor is configured to:
acquire, as the information of an advertisement, electronic data for creating an advertisement medium via the input interface, and
extract an area of characters from the acquired electronic data of the advertisement medium and then recognize characters from the area to detect the words or phrases.

6. The advertisement processing apparatus according to claim 1, wherein the processor is configured to:
convert the created sentence into audio data, and
output the obtained audio data via the output interface.

7. An advertisement processing method for an advertisement processing apparatus, comprising:
acquiring, via an input interface, information of an advertisement;
detecting words or phrases from the acquired information of an advertisement;
determining, for each of the detected words or phrases, meaning of an advertisement represented by the corresponding words or phrases;
generating template data of sales talk on a basis of a combination of the determined meaning of the advertisement;
creating a sentence being sales talk from the generated template data and the detected words or phrases; and
outputting the created sentence via an output interface.

8. The advertisement processing method according to claim 7, wherein
the acquiring of the information of the advertisement includes acquiring image data of an advertisement medium via the input interface, and
the detecting of the words or phrases includes extracting an area of characters from the acquired image data of the advertisement medium and recognizing characters from the area to detect the words or phrases.

9. The advertisement processing method according to claim 7, wherein
the acquiring of the information of the advertisement includes acquiring electronic data for creating an advertisement medium via the input interface, and
the detecting of the words or phrases includes extracting an area of characters from the acquired electronic data of an advertisement medium and recognizing characters from the area to detect the words or phrases.

10. The advertisement processing method according to claim 7, further comprising:
converting the created sentence into audio data, wherein
the outputting of the created sentence includes outputting the obtained audio data via the output interface.
